(19) United States
(12) Patent Application Publication
(10) Pub. No.: US 2020/0398528 A1
(43) Pub. Date: Dec. 24, 2020

(54) Surface and Edge Attachment for Installation of Multi-Component Floor Mat

(71) Applicant: Milliken & Company, Spartanburg, SC (US)

(72) Inventors: Franklin S. Love, Columbus, NC (US); Padmakumar Puthillath, Greer, SC (US); Dale S. Kitchen, Boiling Springs, SC (US)

(73) Assignee: Milliken & Company, Spartanburg, SC (US)

(21) Appl. No.: 17/008,855

(22) Filed: Sep. 1, 2020

Related U.S. Application Data
(63) Continuation of application No. 16/531,072, filed on Aug. 4, 2019.
Application No. 16/531,072 is a division of application No. 15/458,094, filed on Mar. 14, 2017, now abandoned.
(60) Provisional application No. 62/314,495, filed on Mar. 29, 2016.

(51) Int. Cl. B32B 7/06; D06N 7/00; A47L 23/26; B32B 3/06; B32B 3/08; B32B 5/02; B32B 5/06; B32B 7/08; B32B 25/10; B32B 25/16; B32B 37/02; B32B 37/10; B32B 37/18; B32B 38/00; D05C 15/08; D06B 3/10; D06B 5/22; D06F 35/00

(52) U.S. Cl. CPC B32B 7/06; E04F 15/02144; A47L 23/266; B32B 3/06; B32B 3/08; B32B 5/022; B32B 5/06; B32B 7/08; B32B 25/10; B32B 25/16; B32B 37/02; B32B 37/10; B32B 37/182; B32B 38/0004; B32B 38/0012; B32B 38/145; D05C 15/08; D06B 3/10; D06B 5/22; D06F 35/006; D06N 2211/066; D06N 2213/068; D06N 2209/045; D06N 2205/20; D06N 7/0094

(57) ABSTRACT

This invention relates to a washable multi-component floor mat. The floor mat contains a textile component and a base component. The textile component and the base component are attached to one another by at least one surface attraction means and at least one edge attachment means. The textile component is designed to be soiled, washed, and re-used, thereby providing ideal end-use applications in areas such as building entryways. The present invention eliminates the need to wash the base component of the floor mat which results in environmental, cost and labor conservation.

### CROSS REFERENCE TO RELATED APPLICATIONS

This application is a continuation of U.S. patent application Ser. No. 16/531,072, entitled “Surface and Edge Attachment for Installation of Multi-Component Floor Mat” which was filed on Aug. 4, 2019, which is a divisional of U.S. patent application Ser. No. 15/458,094, entitled “Surface and Edge Attachment for Installation of Multi-Component Floor Mat” which was filed on Mar. 14, 2017, which claims priority to U.S. Provisional Patent Application No. 62/314,495, entitled “Surface and Edge Attachment for Installation of Multi-Component Floor Mat” which was filed on Mar. 29, 2016, all of which are entirely incorporated by reference herein.

### TECHNICAL FIELD

This invention relates to a washable multi-component floor mat. The floor mat contains a textile component and a base component. The textile component and the base component are attached to one another by at least one surface attraction means and at least one edge attachment means. The textile component is designed to be soiled, washed, and re-used, thereby providing ideal end-use applications in areas such as building entryways. The present invention eliminates the need to wash the base component of the floor mat which results in environmental, cost and labor conservation.

### BACKGROUND

In making a multi-component floor mat, the ease of deployment and alignment of the mat and mat components is important. Methods of using magnets, hooks, Velcro® fasteners, and the like have been utilized. However, improvements are still needed in order to obtain precise alignment of the mat components in a rapid and efficient manner.

One of the challenges in alignment and deployment of the multi-component mat is that the very forces that hold the components together and resistant to sliding also make alignment and deployment of the mat difficult. This difficulty often requires the installer to stoop down and spend excess time working with the textile component to achieve satisfactory alignment with the base component. It has also been realized that edge attachment is also a need that has not been met. Experience has shown that movement of objects over the multi-component mat sometimes leads to movement (such as roll back and kick up) of the edge of the textile component. Thus, improvement in edge attachment is needed.

The present invention overcomes these challenges via the use of specific edge attachment means. The edge attachment means provide improved edge adherence of the textile component to the base component of the multi-component floor mat.

### BRIEF SUMMARY

In one aspect, the invention relates to a multi-component floor mat comprising: (a) a textile component comprising (i) a first layer of tufted pile carpet formed by tufting face fibers through a primary backing layer and (ii) at least one surface attachment means; and (b) a base component, wherein the base component contains at least one surface attachment means; and wherein the textile component and the base component are releasably attachable to one another via the at least one surface attachment means; and wherein the textile component and the base component further contain at least one edge attachment means.

In another aspect, the invention relates to a multi-component floor mat comprising: (a) a textile component comprising (i) a first layer of tufted pile carpet formed by tufting face fibers through a primary backing layer and (ii) a second layer of vulcanized rubber material that contains magnetic particles; (b) a base component comprised of (i) vulcanized rubber that contains magnetic particles or (ii) vulcanized rubber having a magnetic coating applied thereto; and wherein the textile component and the base component are releasably attachable to one another via magnetic attraction; and wherein the textile component and the base component further contain at least one edge attachment means.

In another aspect, the invention relates to a multi-component floor mat comprising: (a) a textile component comprising (i) tufted pile carpet wherein face fibers are tufted through a primary backing layer and (ii) a magnetic coating wherein the magnetic coating is comprised of magnetic particles and a binder material; (b) a base component comprised of (i) vulcanized rubber that contains magnetic particles or (ii) vulcanized rubber having a magnetic coating applied thereto; wherein the textile component and the base component are releasably attachable to one another via magnetic attraction; and wherein the textile component and the base component further contain at least one edge attachment means.

In a further aspect, the invention relates to a multi-component floor mat comprising: (a) a textile component comprising (i) a first layer of tufted pile carpet wherein face fibers are tufted through a primary backing layer and (ii) a second layer of vulcanized rubber material that contains magnetic particles or a second layer of magnetic coating; (b) a base component comprised of (i) vulcanized rubber and magnetic particles or vulcanized rubber and a magnetic coating and (ii) electronic sensors; wherein the textile component and the base component are releasably attachable to one another via magnetic attraction; and wherein the textile component and the base component further contain at least one edge attachment means.

In yet another aspect, the invention relates to a process for cleaning a multi-component floor mat, said process comprising the steps of: (a) providing the multi-component floor mat of the invention; (b) removing the textile component from the base component; (c) laundering the textile component in an industrial, commercial, or residential washing machine; and (d) re-installing the textile component on or within the base component.

In another aspect, the invention relates to a process for making a multi-component floor mat, said process comprising the steps of: (a) tufting face fibers into a primary backing material to form a tufted pile carpet; (b) optionally, printing the tufted pile carpet; (c) providing a layer of unvulcanized rubber that contains magnetic particles; (d) adhering the tufted pile carpet to the layer of magnetic particle-containing unvulcanized rubber via a rubber vulcanization process to form a washable textile component having a vulcanized rubber backing; (e) cutting the textile component into a desired shape and size; (f) adhering at least one edge attachment means to the washable textile component; (g) providing a base component comprised of (i) vulcanized rubber and magnetic particles or (ii) vulcanized rubber and a magnetic coating; (h) adhering at least one edge attachment means to the base component; and (i) attaching the textile component to the base component via magnetic attraction and edge attachment means.

In another aspect, the invention relates to a process for making a multi-component floor mat, said process comprising the steps of: (a) tufting face fibers into a primary backing material to form a tufted pile carpet; (b) optionally, printing the tufted pile carpet; (c) providing a magnetic coating comprised of magnetic particles and a binder material; (d) adhering the magnetic coating to the tufted pile carpet to form a washable textile component; (e) cutting the textile component into a desired shape and size; (f) adhering at least one edge attachment means to the textile component; (g) providing a base component comprised of (i) vulcanized rubber and magnetic particles or (ii) vulcanized rubber and a magnetic coating; (h) adhering at least one edge attachment means to the base component; and (i) attaching the textile component to the base component via magnetic attraction and edge attachment means.

In yet another aspect, the invention relates to a method for installation of a floor mat comprising the following steps: (a) providing a base component, wherein the base component contains (i) at least one magnetic attachment means and (ii) at least one edge attachment means; (b) providing a textile component, wherein the textile component is comprised of: (i) tufted pile carpet, (ii) at least one magnetic attachment means that works in corresponding relationship with the at least one magnetic attachment means of step “a,” and (iii) at least one edge attachment means that works in corresponding relationship with the at least one edge attachment means of step “a;” and (c) attaching the textile component to the base component, wherein attachment is accomplished via the at least one magnetic attachment means and the at least one edge attachment means, and wherein the base component and the textile component are releasably attachable to one another.

### BRIEF DESCRIPTION OF THE DRAWINGS

FIG. 1A is an expanded side view of a multi-component floor mat comprising a textile component and a base component with surface attachment means and edge attachment means.

FIG. 1B is an expanded side view of a rolled up multi-component floor mat comprising a textile component ready for installation to a base component and including surface attachment means and edge attachment means.

FIG. 1C is a side view of the multi-component floor mat illustrating the configuration of the edge attachment means.

FIG. 2 is a top perspective view of the multi-component floor mat with the textile component partially pulled back from the flat (no recessed area) base component illustrating the hook and loop edge attachment means present on multiple edges of the textile and base components.

FIG. 3 is a top perspective view of the multi-component floor mat with the textile component partially pulled back from the flat (no recessed area) base component illustrating the hook and loop edge attachment means present on only two edges of the floor mat.

FIG. 4A is an expanded side view of a multi-component floor mat comprising a textile component and a base component with alternative edge attachment means.

FIG. 4B is an expanded side view of a rolled up multi-component floor mat comprising a textile component ready for deployment to a base component and including alternative edge attachment means.

FIG. 4C is a side view of the multi-component floor mat illustrating the configuration of an alternative edge attachment means.

FIG. 5 is a top perspective view of the multi-component floor mat with the textile component partially pulled back from the flat (no recessed area) base component illustrating the mushroom-type hook edge attachment means present on only two edges of the floor mat.

FIG. 6 is a top perspective view of the multi-component floor mat with the textile component partially pulled back from the flat (no recessed area) base component illustrating the mushroom-type hook edge attachment means present on only two edges of the floor mat.

FIG. 7A is a schematic diagram illustrating a step in the installation of a multi-component floor mat of the present invention.

FIG. 7B is a schematic diagram illustrating a step in the installation of a multi-component floor mat of the present invention.

FIG. 7C is a schematic diagram illustrating a step in the installation of a multi-component floor mat of the present invention.

FIG. 7D is a schematic diagram illustrating a step in the installation of a multi-component floor mat of the present invention.

FIG. 7E is a schematic diagram illustrating a step in the installation of a multi-component floor mat of the present invention.

FIG. 7F is a schematic diagram illustrating a step in the installation of a multi-component floor mat of the present invention.

FIG. 8A is top perspective view of a multi-component floor mat with one edge of the mat rolled back onto the textile component of the mat to illustrate a weight adhered to the base component.

FIG. 8B is close-up top perspective view of a multi-component floor mat with one edge of the mat rolled back onto the textile component of the mat to illustrate a weight adhered to the base component.

FIG. 9 is a schematic diagram of one embodiment of the manufacturing process of the multi-component floor mat.

### DETAILED DESCRIPTION

The present invention described herein is a method for installing multi-component floor mats. The floor mats are comprised of a textile component and a base component. The method utilizes an edge attachment means for securely and efficiently attaching the textile component to the base component.

The textile component and the base component are releasably attachable to one another via variety of surface attachment means. These include magnetic attraction (such as magnetic coatings, magnetic particles dispersed within a rubber or binder material, spot magnets, and the like), mechanical attachment (such as Velcro® fastening systems, mushroom-shaped protrusions, grommets, and the like), adhesive attraction (such as cohesive materials, silicone materials, and the like), and combinations thereof.

The surface attachment means may be in the form of a coating (such as a magnetic coating), or it may be in the form of discrete attachment mechanisms (such as spot magnets or non-uniform areas of surface attachment means). In one aspect, discrete attachment mechanisms include individual patches of mechanical attachment means. For example, individual patches of Velcro® fastening systems or mushroom-type hook fastening systems may be attached to the textile and base components in a uniform or non-uniform arrangement. For instance, a 1″×1″ Velcro® patch on a 10″×10″ grid may be applied to the textile and base components. In addition, or alternatively, strips of Velcro® or mushroom-type fastening systems may be attached to the approximate center of the textile and base components.

In one aspect, the textile component and the base component are releasably attachable to one another via magnetic surface attraction (such as magnetic coatings, magnetic particles dispersed within a rubber or binder material, spot magnets, and the like). The edge attachment means is used in addition to the magnetic surface attraction in order to secure the textile component to the base component.

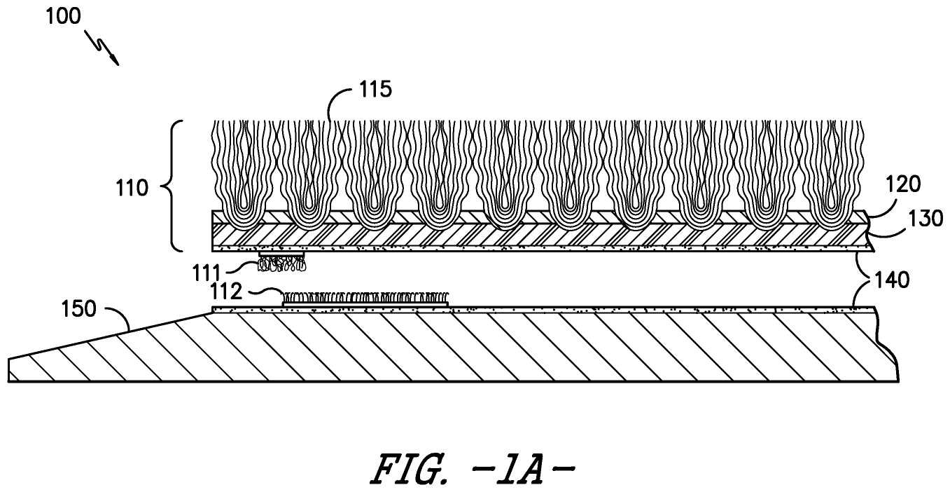

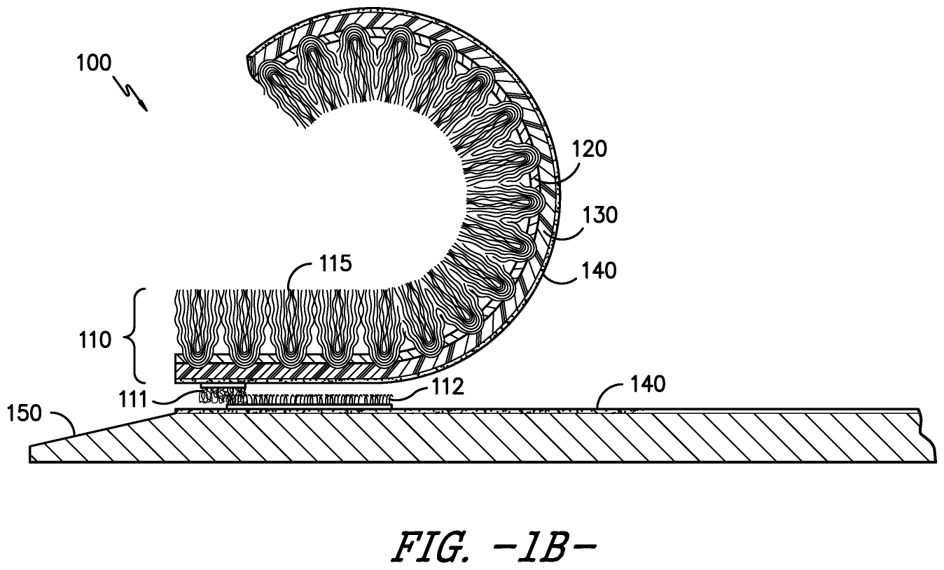

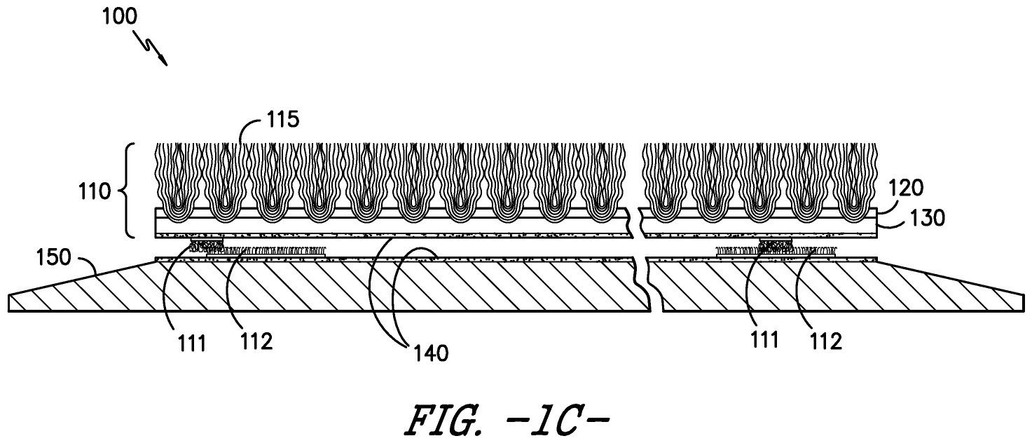

Referring now to the Figures, FIG. 1A illustrates a multi-component floor mat 100 comprised of a textile component 110 and a base component 150. Textile component 110 is comprised of face fibers 115 tufted through a primary backing layer 120. An optional secondary backing layer 130 comprised of vulcanized rubber may also be included. The textile component 110 further includes a magnetic coating 140. A magnetic coating 140 may also be added to base component 150. Application of magnetic coating layer 140 to the textile and base components will be described in greater detail below. The resulting textile component 110 is wash durable and exhibits sufficient tuft lock for normal end-use applications.

FIG. 1A further illustrates one embodiment of an edge attachment means. Edge attachment means include hook and loop fastening systems (such as Velcro® fasteners), mushroom-type hook fastening systems (such as Dual Lock™ fasteners from 3M), and the like, and combinations thereof. As shown in FIG. 1A, loop portion 111 is attached to textile component 110. Hook portion 112 is attached to base component 150. The alternative arrangement of loop and hook portions is also contemplated to be within the scope of this invention wherein the loop portion is attached to the base component and the hook portion is attached to the textile component.

FIG. 1B illustrates the multi-component floor mat 100 of FIG. 1A whereby textile component 110 is rolled up into a roll and then placed down on the base component 150. Loop portion 111 of textile component 110 and hook portion 112 of base component 150 are spatially aligned with one another. After installation of multi-component floor mat 100, loop portion 111 and hook portion 112 are in physical contact with one another and provide secure adherence of textile component 110 to base component 150. FIGS. 1A and 1B also illustrate a multi-component floor mat 100 wherein textile component 110 is combined with base component 150 that is flat and has no recessed area (i.e. the base component is trayless).

FIG. 1C illustrates multi-component floor mat 100 wherein loop portion 111 is in lateral (i.e. side-by-side) engagement with hook portion 112 on the left side of mat 100. In this instance, only a portion of loop portion 111 is in physical contact with hook portion 112. In contrast, on the right side of mat 100, FIG. 10 illustrates that loop portion 111 is entirely in physical contact with hook portion 112. In this instance, all of loop portion 111 is horizontally engaged with all of hook portion 112. The physical arrangement of loop and hook portions illustrated in FIG. 10 results from the installation method utilized and further described herein.

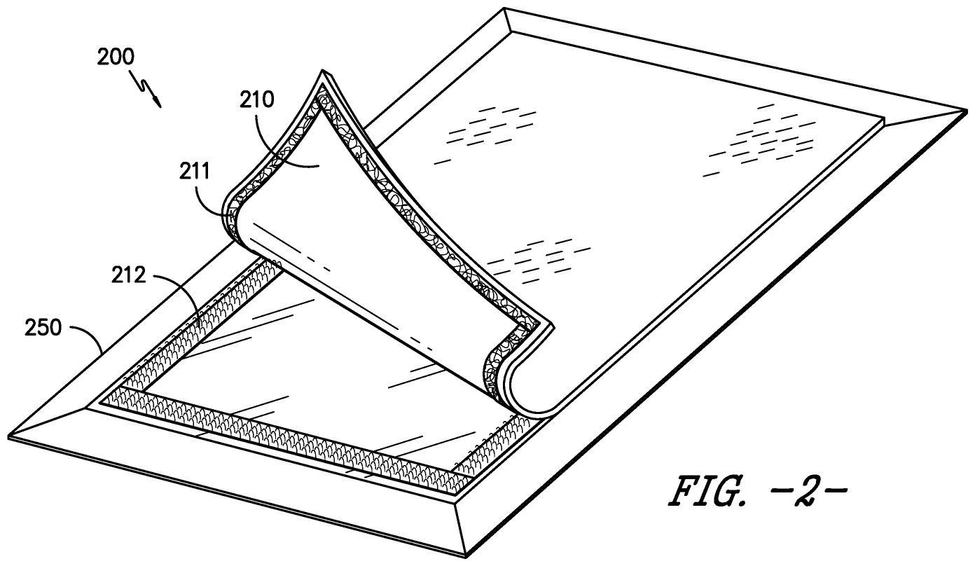

FIG. 2 illustrates a multi-component floor mat 200 with textile component 210 and base component 250 having edge attachment means. Textile component 210 is shown with the loop portion 211 of a hook and loop fastening system (such as Velcro® fasteners) attached to the non-pile carpet surface of the textile component 210. In this embodiment, loop portion 211 is a narrow strip of loop fasteners extending all the way around the interior edge of the textile component 210.

FIG. 2 further illustrates base component 250 with edge attachment means. Base component 250 is shown with the hook portion 212 of a hook and loop fastening system (such as Velcro® fasteners) attached to base component 250. In this embodiment, hook portion 212 is a narrow strip of hook fasteners extending all the way around the interior edge of base component 250. Thus, the configuration illustrated in FIG. 2 provides hook and loop fastening strips along all four planar edge surfaces of both the textile and base components.

FIG. 3 illustrates a multi-component floor mat 300 with textile component 310 and base component 350 having edge attachment means. Textile component 310 is shown with the loop portion 311 of a hook and loop fastening system (such as Velcro® fasteners) attached to the non-pile carpet surface of textile component 310. In this embodiment, loop portion 311 is a narrow strip of loop fasteners extending across both of short ends of textile component 310. While only visible at one end in FIG. 3, loop portion 311 is also present at the opposite end of floor mat 300.

FIG. 3 further illustrates base component 350 with edge attachment means. Base component 350 is shown with the hook portion 312 of a hook and loop fastening system (such as Velcro® fasteners) attached to base component 350. In this embodiment, hook portion 312 is a narrow strip of hook fasteners extending across both short ends of base component 350. Thus, the configuration illustrated in FIG. 3 provides hook and loop fastening strips along only two planar edge surfaces of both the textile and base components.

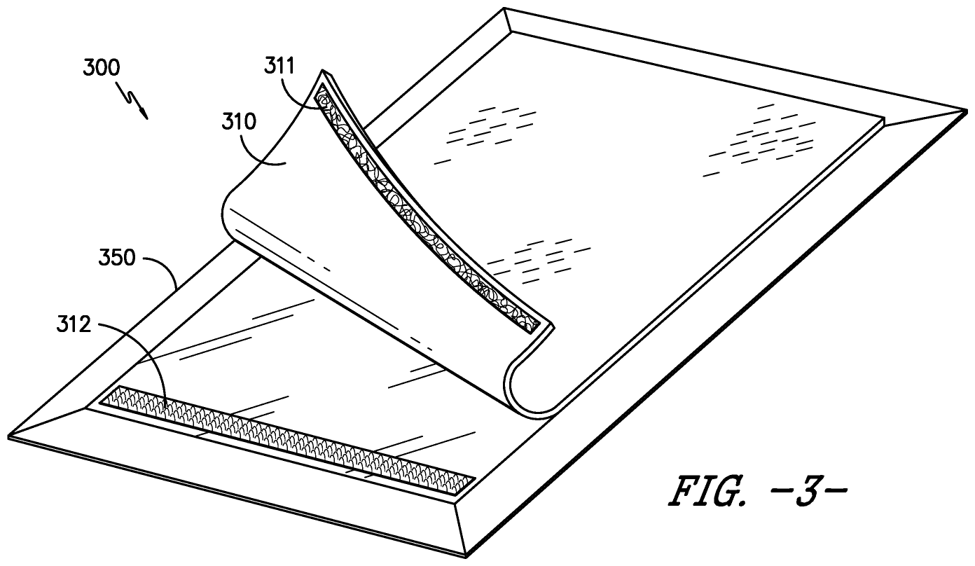

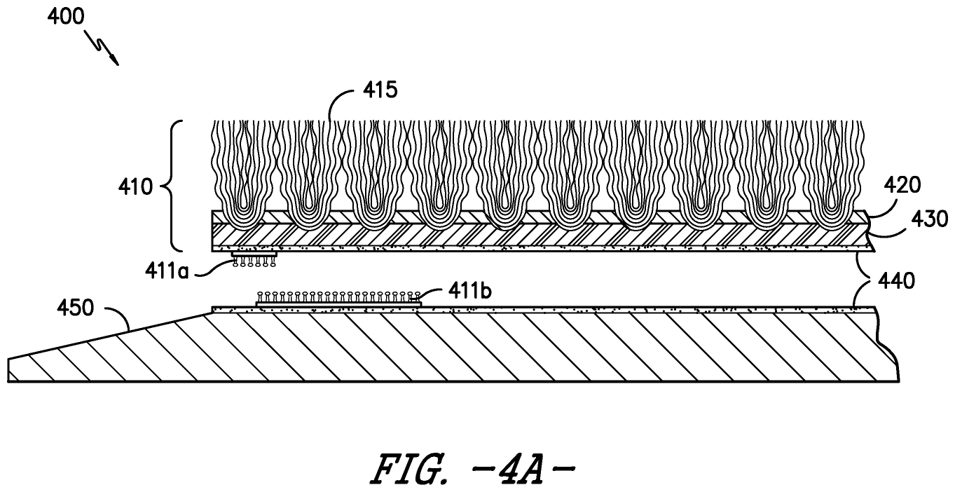

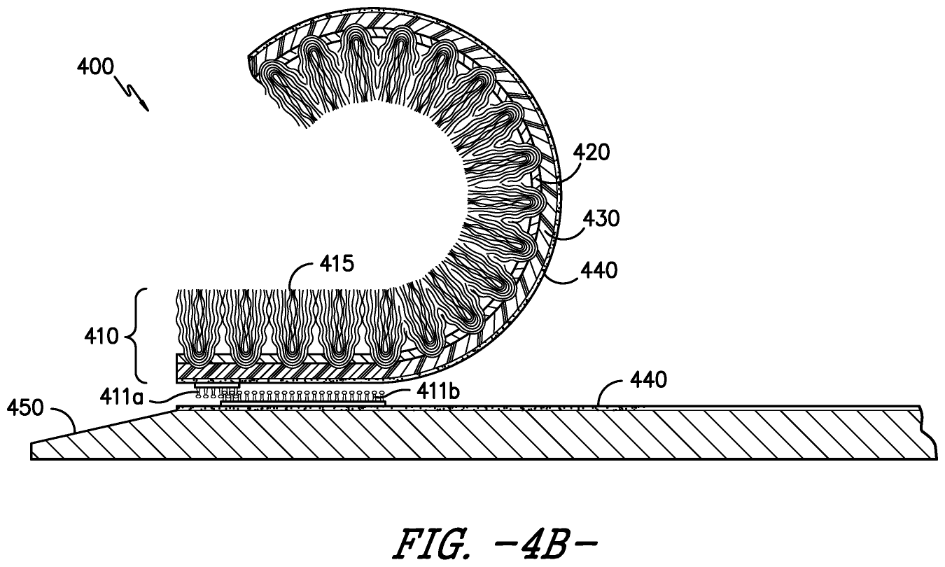

FIG. 4A illustrates a multi-component floor mat 400 comprised of a textile component 410 and a base component 450. Textile component 410 is comprised of face fibers 415 tufted through a primary backing layer 420. An optional secondary backing layer 430 comprised of vulcanized rubber may also be included. The textile component 410 further includes a magnetic coating 440. A magnetic coating 440 may also be added to base component 450. FIG. 4A illustrates another embodiment of an edge attachment means. As shown in FIG. 4A, mushroom-type hook fasteners 411a are attached to textile component 410 and mushroom-type hook fasteners 411b are attached to base component 450.

FIG. 4B illustrates the multi-component floor mat 400 of FIG. 4A whereby textile component 410 is rolled up into a roll and then placed down on the base component 450. Mushroom-type hook fasteners 411a of textile component 410 and mushroom-type hook fasteners 411b of base component 450 are spatially aligned with one another. After installation of multi-component floor mat 400, mushroom-type hook fasteners 411a and 411b are in physical contact with one another and provide secure adherence of textile component 410 to base component 450.

FIG. 4C illustrates multi-component floor mat 400 wherein mushroom-type hook fasteners 411a are in lateral (i.e. side-by-side) engagement with mushroom-type hook fasteners 411b on the left side of mat 400. In this instance, only a portion of mushroom-type hook fasteners 411a are in physical contact with mushroom-type hook fasteners 411b. In contrast, on the right side of mat 400, FIG. 4C illustrates that mushroom-type hook fasteners 411a are entirely in physical contact with mushroom-type hook fasteners 411b. In this instance, all of mushroom-type hook fasteners 411a are horizontally engaged with all of mushroom-type hook fasteners 411b. The physical arrangement of loop and hook portions illustrated in FIG. 4C results from the installation method utilized and further described herein.

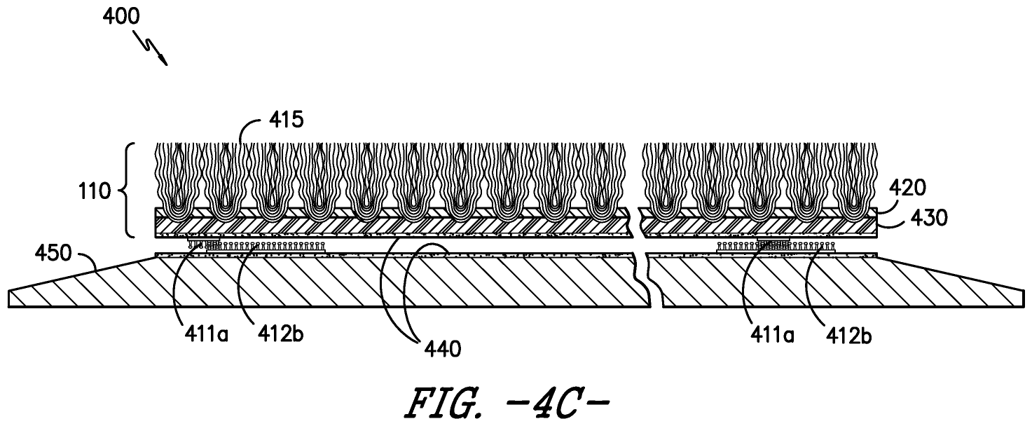

FIG. 5 illustrates another embodiment of a multi-component floor mat 500 with textile component 510 and base component 550 having edge attachment means. Textile component 510 is shown with mushroom-type hook fasteners 511a (such as Dual Lock™ fasteners from 3M) attached to the non-pile carpet surface of textile component 510. In this embodiment, mushroom-type hook fasteners 511a are provided as a narrow strip which extends all the way around the interior edge of textile component 510.

FIG. 5 further illustrates base component 550 with edge attachment means. Base component 550 is shown with mushroom-type hook fasteners 511b (such as Dual Lock™ fasteners from 3M) attached to base component 550. In this embodiment, mushroom-type hook fasteners 511b are provided as a narrow strip which extends all the way around the interior edge of base component 550. Thus, the configuration illustrated in FIG. 5 provides mushroom-type hook fastening strips along all four planar edge surfaces of both the textile and base components.

FIG. 6 illustrates a multi-component floor mat 600 with textile component 610 and base component 650 having edge attachment means. Textile component 610 is shown with mushroom-type hook fasteners 611a (such as Dual Lock™ fasteners from 3M) attached to the non-pile carpet surface of textile component 610. In this embodiment, mushroom-type hook fasteners 611a are provided as a narrow strip of fasteners extending across both of short ends of textile component 610. While only visible at one end of FIG. 6, mushroom-type hook fasteners 611a are also present at the opposite end of floor mat 600.

FIG. 6 further illustrates base component 650 with edge attachment means. Base component 650 is shown with mushroom-type hook fasteners 611b (such as Dual Lock™ fasteners from 3M) attached to base component 650. In this embodiment, mushroom-type hook fasteners 611b are provided as a narrow strip of fasteners extending across both short ends of base component 650. Thus, the configuration illustrated in FIG. 6 provides mushroom-type hook fastening strips along only two planar edge surfaces of both the textile and base components.

The edge attachment means comprises a certain width and length. Any combination of width and length described herein may be utilized for the edge attachment means of the floor mat of the present invention. In one aspect, the width of the edge attachment means is in the range from 0.01 inches to 5 inches, or in the range from 0.1 inches to 4 inches, or in the range from 0.2 inches to 3 inches, or in the range from 0.2 inches to 2.5 inches, or in the range from 0.2 inches to 2 inches, or in the range from 0.2 inches to 1.5 inches, or in the range from 0.2 inches to 1 inch, or in the range from 0.2 inches to 0.5 inches. In one aspect, the width of the edge attachment means is 0.25 inches.

In one aspect, the length of the edge attachment means is the same as the width and/or length of the floor mat corresponding to the area to which it is applied. In another aspect, the length of the edge attachment means is less than the width and/or length of the floor mat corresponding to the area to which it is applied. For example, when the length of the edge attachment means is less than the width of the floor mat, the length may be 1 inch less than the width of the floor mat, or 2 inches less than the width of the floor mat, or 3 inches less than the width of the floor mat, or 4 inches less than the width of the floor mat, or even 5 inches less than the width of the floor mat. In another aspect, the length of the edge attachment means may be in the range from 0.1 inches to 20 inches less than the width of the floor mat, or in the range from 0.1 inches to 15 inches less than the width of the floor mat, or in the range from 0.1 inches to 10 inches less than the width of the floor mat, or even in the range from 0.1 inches to 5 inches less than the width of the floor mat. In a similar manner, when the length of the edge attachment means is less than the length of the floor mat, the length of the edge attachment means may be 1 inch less than the length of the floor mat, or 2 inches less than the length of the floor mat, or 3 inches less than the length of the floor mat, or 4 inches less than the length of the floor mat, or even 5 inches less than the length of the floor mat. In another aspect, the length of the edge attachment means may be in the range from 0.1 inches to 20 inches less than the length of the floor mat, or in the range from 0.1 inches to 15 inches less than the length of the floor mat, or in the range from 0.1 inches to 10 inches less than the length of the floor mat, or even in the range from 0.1 inches to 5 inches less than the length of the floor mat.

For instances wherein a hook and loop combination is utilized as the edge attachment means, the loop portion and hook portion may be the same length and width. Or, the loop portion and hook portion may have different lengths and/or different widths. Alternatively, for instances wherein mushroom-type hook fasteners are utilized as the edge attachment means, the portion attached to the textile component and the portion attached to the base component may have the same length and width. Or, the mushroom-type hook fastener portion attached to the textile component may have a different length and/or width than the mushroom-type hook fastener portion attached to the base component.

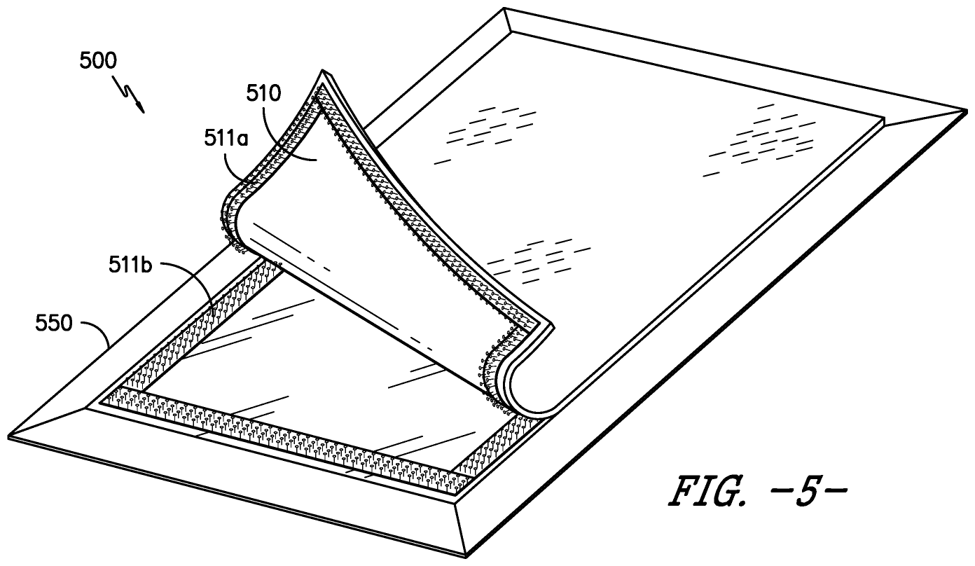

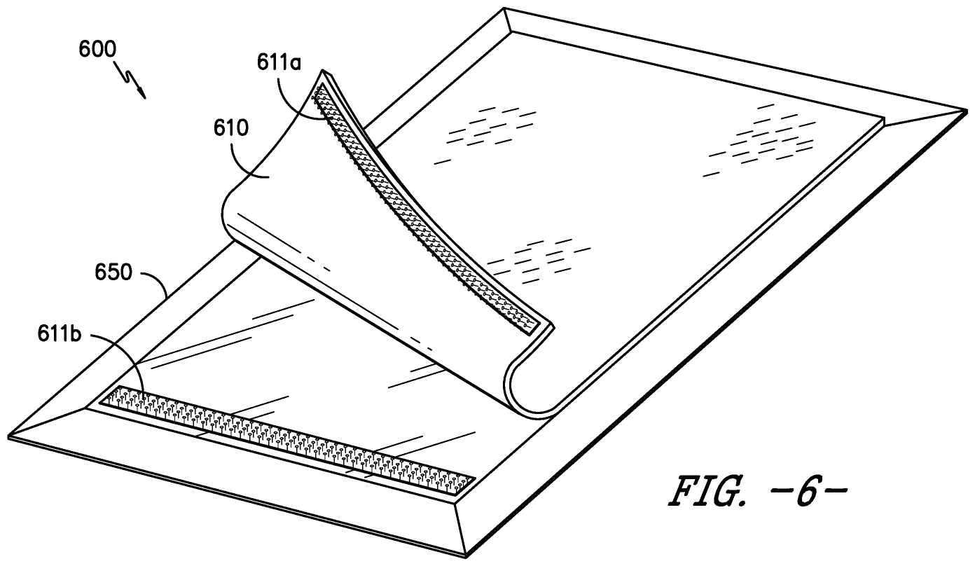

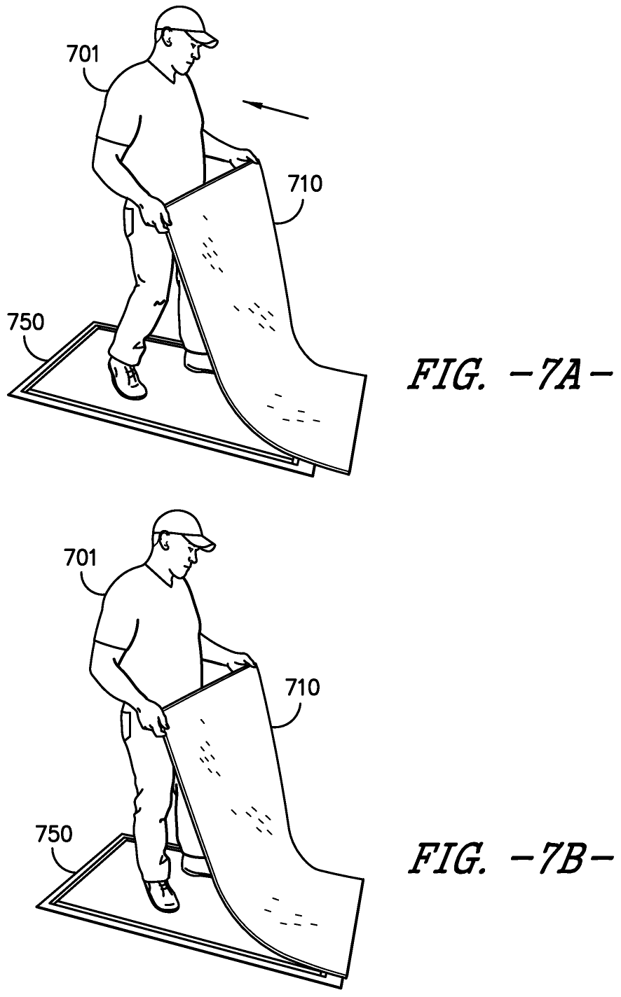

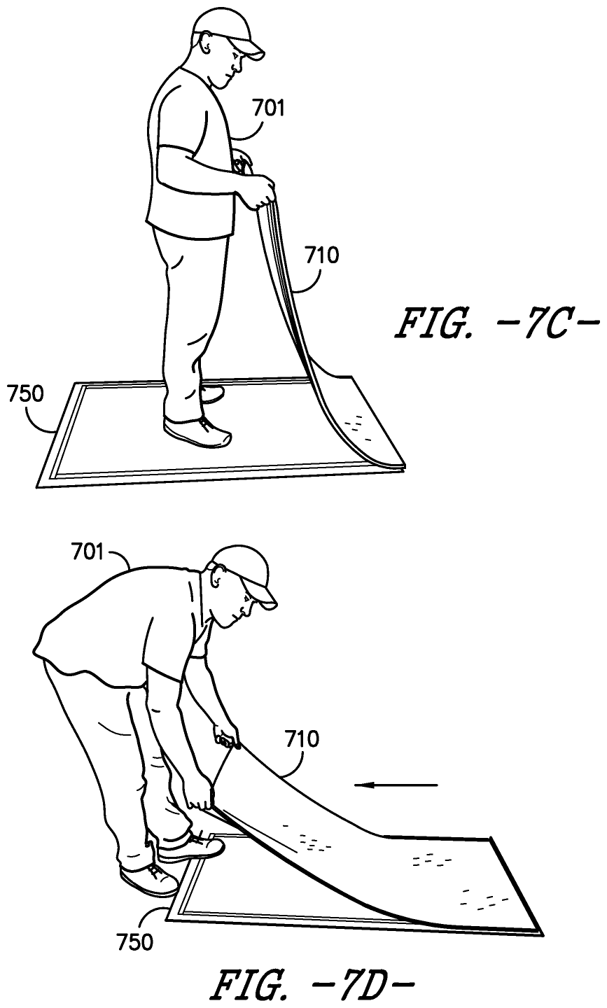

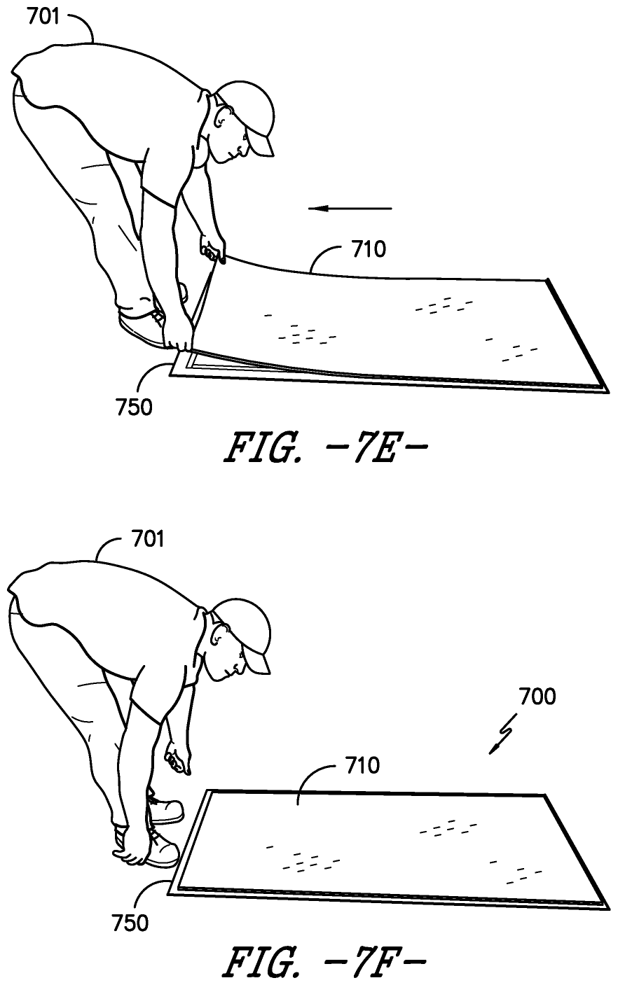

FIGS. 7A-7F illustrate the installation method for the multi-component floor mat of the present invention. FIG. 7A shows a person (“installer”) 701 preparing to install a multi-component floor mat according to the present invention. The installer 701 is shown standing on base component 750 and holding textile component 710. The arrow indicates the direction of force being applied to textile component 710 by installer 701 in order to prepare the components of the floor mat for installation. FIG. 7B is another view of the installation process showing textile component 710 moved closer to alignment with base component 750. FIG. 7C is another view of the installation process showing textile component 710 moved even closer to alignment with base component 750. The installer 701 is holding textile component 710 so that the pile carpet is facing away from base component 750 and the edge attachment means is facing toward base component 750. The installer 701 has aligned one edge of textile component 710 with base component 750. FIG. 7D shows installer 701 lowering textile component 710 onto base component 750. The arrow again indicates the direction of force applied to textile component 710 by installer 701. FIG. 7E shows textile component 710 almost completely lowered onto base component 750 by installer 701. The arrow again indicates the direction of force applied to textile component 710 by installer 701. FIG. 7F shows multi-component floor mat 700 after installation by installer 701. The textile component 710 is properly aligned onto and deployed with base component 750. The installer 701 was able to easily install multi-component floor mat 700 while remaining in the standing position (i.e. feet on the floor; not on his/her hands and/or knees) and without having to adjust and/or re-align textile component 710 with base component 750.

It is noted that this installation technique allows the loop portion and hook portion edge attachment means to self-align with one another by pulling one onto, or into lateral side-by-side arrangement with, the other. It has been further discovered that the edge attachment means (e.g. loop and hook portions) have a sliding friction that is low enough to allow dragging yet strong enough to provide edge hold down once the edges are stepped on. In this regard, the textile component and the base component may possess a certain range of peel strength and shear strength with respect to one another. In one aspect, a suitable amount of peel strength between the textile component and the base component is in the range from 0.3 pounds per inch width to 5 pounds per inch width. A suitable amount of shear strength between the textile component and the base component is in the range from 5 pounds per square inch to 100 pounds per square inch.

As shown in FIGS. 7A-7F, the person installing the multi-component floor mat simply moves the textile component over the top of the base component, aligning it with left and right alignment marks to achieve horizontal alignment. The textile component is then automatically locked down on the alignment end in near perfect angular and vertical alignment with the base component. Once the alignment end is locked down to the base component, the installer can then assert tension to the textile component by pulling it onto the base component and dropping the textile component onto the near end of the base component using a second set of alignment marks. The result is that the textile component is in near perfect in vertical, horizontal and angular alignment with the base component. The installation of the multi-component floor mat is achieved quickly and by an installer that can remain in the standing position (e.g. feet flat on the floor).

As further illustrated by FIGS. 7A-7F, the installation of the floor mat may include movement of the textile component to the base component by dragging the textile component to the base component. The textile component may be dragged to the base component until the edge attachment means of the textile component (e.g. the loop portion of the edge attachment means) comes into physical contact with the edge attachment means of the base component (e.g. the hook portion of the edge attachment means). In one aspect, the dragging movement may continue until the edge attachment means of the textile component (e.g. the loop portion of the edge attachment means) comes into lateral side-by-side contact with the edge attachment means of the base component (e.g. the hook portion of the edge attachment means).

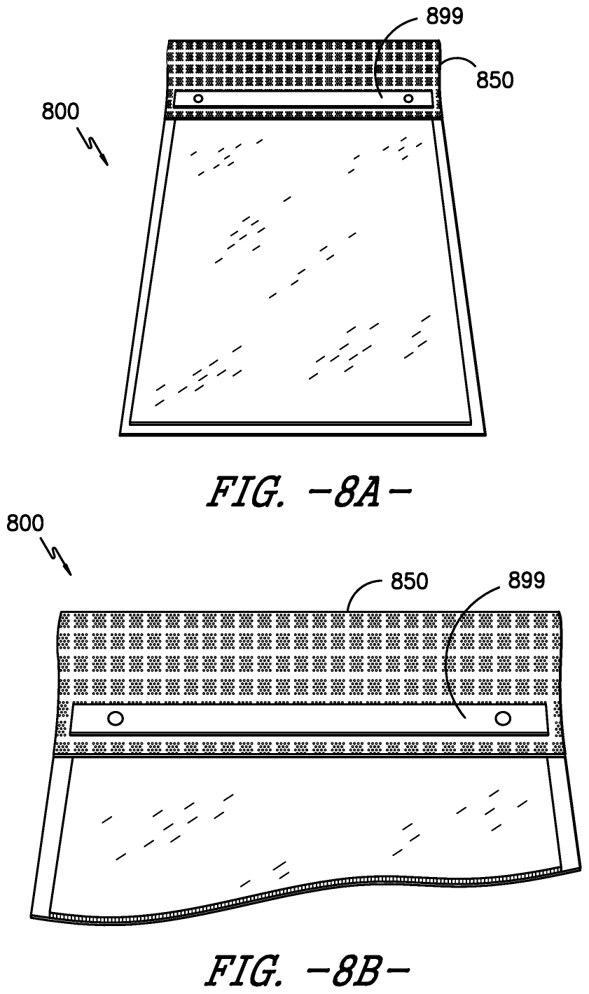

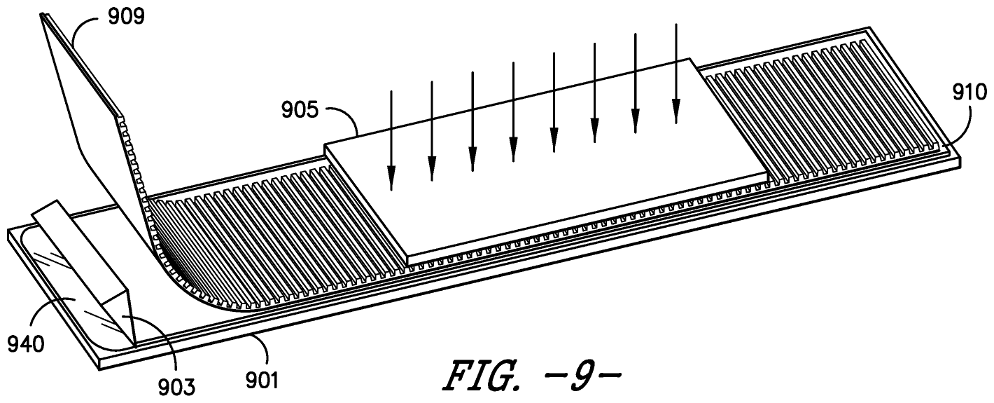

FIG. 8A illustrates a multi-component floor mat 800 with the added feature of a stabilizer 899 attached to the base component 850. The stabilizer 899 assists in providing additional weight and/or stability to multi-component floor mat 800. The stabilizer 899 shown in FIG. 8A is a stainless steel bar. However, any material that provides the desired weight and/or stability to the floor mat may be used. Non-limiting suitable materials include metal, rubber (e.g. dense rubber), and the like, and combinations thereof. FIG. 8B is a close-up view of a portion of multi-component floor mat 800 with stabilizer 899 of FIG. 8A.

In another aspect of the invention, clips (such as “L-clips”), or other suitable pinching mechanisms, may be used in the installation process of the floor mat. Herein, the clips may be used to hold the textile component and the base component together while the installer aligns and installs the floor mat. After installation, the clips (or other pinching mechanisms) may be removed from the floor mat.

As mentioned previously, the base component of the floor mat may be flat and have no recessed area (i.e. the base component is trayless). A flat base component is manufactured from a sheet of material, such as a rubber material, that has been cut in the desired shape and vulcanized. The base component is sized to accommodate the textile component. The base component may also include a border surrounding the tray, whereby the border provides greater dimensional stability to the tray. Additionally, the border may be angled upward from its outer perimeter towards the interior of the base component, thereby creating a substantially level area between the inner perimeter of the border and the textile component, when the textile component overlays the tray. Additionally, the gradual incline from the outer perimeter of the border to the inner perimeter of the border minimizes tripping hazards and the recess created thereby protects the edges of the textile component.

Examples of suitable compositions for forming the base component are elastomers, such as natural and synthetic rubber materials, thermoplastic and thermoset resins and metal. The rubber material may be selected from the group consisting of nitrile rubber, including dense nitrile rubber, foam nitrile rubber, and mixtures thereof; polyvinyl chloride rubber; ethylene propylene diene monomer (EPDM) rubber; vinyl rubber; thermoplastic elastomer; and mixtures thereof. In one aspect, the base component is typically comprised of at least one rubber material. The rubber material may contain from 0% to 49% of a recycled rubber material.

FIGS. 8A and 8B illustrate one embodiment of the back surface of the base component. The back surface of the base component is the surface which lies on the floor and therefore has direct contact with the surface of the floor. Various patterns and/or protrusions on the back surface of the base component may be present so as to facilitate the base component's adherence to the floor. Protrusions may be present on the back surface of base component 850. The protrusions may be present in a repeating pattern such that a three dimensional array of protrusions is formed having a uniform pattern.

Floor mats of the present invention may be of any geometric shape or size as desired for its end-use application. The longitudinal edges of the floor mats may be of the same length and width, thus forming a square shape. Or, the longitudinal edges of the floor mats may have different dimensions such that the width and the length are not the same. Alternatively, the floor mats may be circular, hexagonal, and the like. As one non-limiting example, floor mats of the present invention may be manufactured into any of the current industry standards sizes that include 2 feet by 4 feet, 3 feet by 4 feet, 3 feet by 5 feet, 4 feet by 6 feet, 3 feet by 10 feet, and the like. In one aspect, the textile component and the base component have the same dimensions. In another aspect, the textile component and the base component have different dimensions. For example, the textile component may be smaller is size than the base component. In this example, at least a portion of the base component is visible in a top perspective view of the multi-component floor mat.

As described herein, in one aspect, the textile component and the base component are held together, at least in part, by magnetic attraction. Magnetic attraction is achieved via application of a magnetic coating to the textile component and/or base component or via incorporation of magnetic particles in a rubber-containing layer prior to vulcanization. Alternatively, magnetic attraction can be achieved using both methods such that a magnetic coating is applied to the textile component and magnetic particles are included in the vulcanized rubber of the base component. The inverse arrangement is also contemplated.

The magnetic coating may be applied to the textile component and/or the base component by several different manufacturing techniques. Exemplary coating techniques include, without limitation, knife coating, pad coating, paint coating, spray application, roll-on-roll methods, troweling methods, extrusion coating, foam coating, pattern coating, print coating, lamination, and mixtures thereof.

FIG. 9 illustrates one embodiment of the manufacturing process of the textile component of the present invention. The uncoated tufted pile carpet 909 is fed to laminating belt 901. The belt moves through the coating zone to lamination zone of the lamination press. A magnetic coating 940 is fed transversely to laminating belt 901. As magnetic coating 940 is fed to laminating belt 901, it passes under coating knife 903. The coating knife 903 is adjusted so that the desired coating thickness is achieved. For example, a magnetic coating thickness of 25 mil may be desirable. After magnetic coating 940 passes under coating knife 903, it comes into contact with tufted pile carpet 909. The magnetic coating 940 and tufted pile carpet 909 then move transversely to laminating press 905. Laminating press 905 is located above laminating belt 901. The laminating press 905 is lowered onto laminating belt 901, pressing tufted pile carpet 909 and magnetic coating 940 together. The laminating press 905 is heated and therefore provides both heat and pressure to the lamination process. Providing heat at this point of the lamination process further serves to cure any materials (e.g. binder materials) that may be contained within the magnetic coating. After a pre-determined amount of time, laminating press 905 is lifted from laminating belt 901. The magnetic coating 940 is now laminated to tufted pile carpet 909 to form textile component 910. In one aspect, the laminating press may be operated at a temperature in the range from 200° F. to 500° F. and at a pressure in the range from 10 psi to 50 psi, or even at 300° F. and a pressure of 36 psi.

In instances wherein magnetic attraction is achieved by incorporating magnetic particles in a rubber-containing layer, the following procedure may be utilized: (a) an unvulcanized rubber-containing material is provided (such as nitrile, SBR, or EPDM rubber), (b) magnetic particles are added to the unvulcanized rubber, (c) the particles are mixed with the rubber, and (d) the mixture of step “c” is formed into a sheet and attached to the bottom of the textile component and/or represents the base component. Mixing in step “c” may be achieved via a rubber mixing mill.

In this application, magnetizable is defined to mean the particles present in the coating or vulcanized rubber layer are permanently magnetized or can be magnetized permanently using external magnets or electromagnets. Once the particles are magnetized, they will keep their magnetic response permanently. The magnetizable behavior for generating permanent magnetism falls broadly under ferromagnets and ferrimagnets. Barium ferrites, strontium ferrites, neodymium and other rare earth metal based alloys are non-limiting examples of materials that can be applied in the magnetic coatings and/or vulcanized rubber layer.

As used herein, magnetically responsive is defined to mean the particles present in the coating and/or vulcanized rubber layer are only magnetically responsive in the presence of external magnets. The component that contains the magnetic particles is exposed to a magnetic field which aligns the dipoles of magnetic particles. Once the magnetic field is removed from the vicinity, the particles will become non-magnetic and the dipoles are no longer aligned. The magnetically responsive behavior or responsive magnetic behavior falls broadly under paramagnets or superparamagnets (particle size less than 50 nm).

This feature of materials being reversibly magnetic occurs when the dipoles of the superparamagnetic or paramagnetic materials are not aligned, but upon exposure to a magnet, the dipoles line up and point in the same direction thereby allowing the materials to exhibit magnetic properties. Non-limiting examples of materials exhibiting these features include iron oxide, steel, iron, nickel, aluminum, or alloys of any of the foregoing.

Further examples of magnetizable magnetic particles include BaFe₃O₄, SrFe₃O₄, NdFeB, AlNiCo, CoSm and other rare earth metal based alloys, and mixtures thereof. Examples of magnetically responsive particles include Fe₂O₃, Fe₃O₄, steel, iron particles, and mixtures thereof. The magnetically receptive particles may be paramagnetic or superparamagnetic. The magnet particles are typically characterized as being non-degradable.

In one aspect of the invention, particle size of the magnetically receptive particles is in the range from 1 micron to 10 microns. Particle size of the magnetically receptive particles may be in the range from 10 nm to 50 nm for superparamagnetic materials. Particle size of the magnetically receptive particles is typically greater than 100 nm for paramagnetic and/or ferromagnetic materials.

Magnetic attraction is typically exhibited at any loading of the above magnetic materials. However, the magnetic attraction increases as the loading of magnetic material increases. In one aspect of the invention, the magnetic field strength of the textile component to the base component is greater than 50 gauss, more preferably greater than 100 gauss, more preferably greater than 150 gauss, or even more preferably greater than 200 gauss.

In one aspect, the magnetic material is present in the coating composition in the range from 25% to 95% by weight of the coating composition. In another aspect, magnetic particle loading may be present in the magnetic coating applied to the textile component in the range from 10% to 70% by weight of the textile component. The magnetic particle loading may be present in the magnetic coating applied to the base component in the range from 10% to 90% by weight of the base component.

The magnetically receptive particles may be present in the vulcanized rubber layer of the textile component in a substantially uniform distribution. In another aspect of the present invention, it is contemplated that the magnetically receptive particles are present in the rubber layer of the textile component in a substantially non-uniform distribution. One example of a non-uniform distribution includes a functionally graded particle distribution wherein the concentration of particles is reduced at the surface of the textile component intended for attachment to the base component. Alternatively, another example of a non-uniform distribution includes a functionally graded particle distribution wherein the concentration of particles is increased at the surface of the textile component intended for attachment to the base component.

The magnetic attraction between the textile component and the base component may be altered by manipulation of the surface area of one or both of the textile and/or base components. The surfaces of one or both of the components may be textured in such a way that surface area of the component is increased. Such manipulation may allow for customization of magnetic attraction that is not directly affected by the amount of magnetic particles present in the floor mat.

For instance, a substantially smooth (less surface area) bottom surface of the textile component will generally result in greater magnetic attraction to the top surface of the base component. In contrast, a less smooth (more surface area) bottom surface of the textile component (e.g. one having ripples or any other textured surface) will generally result in less magnetic attraction to the top surface of the base component. Of course, a reverse arrangement is also contemplated wherein the base component contains a textured surface. Furthermore, both component surfaces may be textured in such a way that magnetic attraction is manipulated to suit the end-use application of the inventive floor mat.

As discussed previously, the magnetic particles may be incorporated into the floor mat of the present invention either by applying a magnetic coating to surface of the textile component or by including the particles in the rubber material of the textile material and/or the base component prior to vulcanization. When incorporation is via a magnetic coating, a binder material is generally included. Thus, the magnetic coating is typically comprised of at least one type of magnetic particles and at least one binder material.

The binder material is typically selected from a thermoplastic elastomer material and/or a thermoplastic vulcanite material. Examples include urethane-containing materials, acrylate-containing materials, silicone-containing materials, and mixtures thereof. Barium ferrites, strontium ferrites, neodymium and other rare earth metal based alloys can be mixed with the appropriate binder to be coated on the textile and/or base component.

In one aspect, the binder material will exhibit at least one of the following properties: (a) a glass transition (T_{g}) temperature of less than 10° C.; (b) a Shore A hardness in the range from 30 to 90; and (c) a softening temperature of greater than 70° C.

In one aspect, an acrylate and/or urethane-containing binder system is combined with Fe₃O₄ to form the magnetic coating of the present invention. The ratio of Fe₃O₄:acrylate and/or urethane binder is in the range from 40-70%: 60:30% by weight. The thickness of the magnetic coating may be in the range from 10 mil to 40 mil. Such a magnetic coating exhibits flexibility without any cracking issues.

Following application or inclusion of the magnetic particles into the textile and/or base component, the particles need to be magnetized. Magnetization can occur either during the curing process or after the curing process. Curing is typically needed for the binder material that is selected and/or for the rubber material that may be selected.

During the curing process, the magnetizable particles are mixed with the appropriate binder and applied via a coating technique on the substrate to be magnetized. Once the coating is complete, the particles are magnetized in the presence of external magnets during the curing process. The component that contains the magnetic particles is exposed to a magnetic field which aligns the dipoles of magnetic particles, locking them in place until the binder is cured. The magnetic field is preferably installed in-line as part of the manufacturing process. However, the magnetic field may exist as a separate entity from the rest of the manufacturing equipment.

Alternatively, the magnetic particles may be magnetized after the curing process. In this instance, the magnetizable particles are added to the binder material and applied to the textile and/or base component in the form of a film or coating. The film or coating is then cured. The cured substrate is then exposed to at least one permanent magnet. Exposure to the permanent magnet may be done via direct contact with the coated substrate or via indirect contact with the coated substrate. Direct contact with the permanent magnet may occur, for example, by rolling the permanent magnet over the coated substrate. The magnet may be rolled over the coated substrate a single time or it may be rolled multiple times (e.g. 10 times). The permanent magnet may be provided in-line with the manufacturing process, or it may exist separately from the manufacturing equipment. Indirect contact may include a situation wherein the coated substrate is brought close to the permanent magnet, but does not contact or touch the magnet.

Depending upon the pole size, strength and domains on the permanent magnet (or electromagnet), it can magnetize the magnetizable coating to a value between 10 and 5000 gauss or a value close to the maximum gauss value of the magnetizing medium. Once the coating is magnetized, it will typically remain permanently magnetized.

The base component of the floor mat may be partially or wholly covered with a textile component. Typically, the textile component will be lighter in weight than the base component. Inversely, the base component will weigh more than the textile component.

With respect to the textile component itself, the textile component may be comprised of tufted pile carpet. The tufted pile carpet is comprised of a primary backing layer and face fibers. The primary backing layer is typically included in the tufted pile carpet to give stability to the face fibers. The materials comprising the face fibers and the primary backing layer may independently be selected from synthetic fiber, natural fiber, man-made fiber using natural constituents, inorganic fiber, glass fiber, and a blend of any of the foregoing. By way of example only, synthetic fibers may include polyester, acrylic, polyamide, polyolefin, polyaramid, polyurethane, or blends thereof. More specifically, polyester may include polyethylene terephthalate, polytrimethylene terephthalate, polybutylene terephthalate, polylactic acid, or combinations thereof. Polyamide may include nylon 6, nylon 6,6, or combinations thereof. Polyolefin may include polypropylene, polyethylene, or combinations thereof. Polyaramid may include poly-p-phenyleneteraphthalamide (i.e., Kevlar®), poly-m-phenyleneteraphthalamide (i.e., Nomex®), or combinations thereof. Exemplary natural fibers include wool, cotton, linen, ramie, jute, flax, silk, hemp, or blends thereof. Exemplary man-made materials using natural constituents include regenerated cellulose (i.e., rayon), lyocell, or blends thereof.

The material comprising the face fibers and primary backing layer may be formed from staple fiber, filament fiber, slit film fiber, or combinations thereof. The fiber may be exposed to one or more texturing processes. The fiber may then be spun or otherwise combined into yarns, for example, by ring spinning, open-end spinning, air jet spinning, vortex spinning, or combinations thereof. Accordingly, the material comprising the face fibers will generally be comprised of interlaced fibers, interlaced yarns, loops, or combinations thereof.

The material comprising the face fibers and the primary backing layer may be comprised of fibers or yarns of any size, including microdenier fibers or yarns (fibers or yarns having less than one denier per filament). The fibers or yarns may have deniers that range from less than about 0.1 denier per filament to about 2000 denier per filament or, more preferably, from less than about 1 denier per filament to about 500 denier per filament.

Furthermore, the material comprising the face fibers and the primary backing layer may be partially or wholly comprised of multi-component or bi-component fibers or yarns in various configurations such as, for example, islands-in-the-sea, core and sheath, side-by-side, or pie configurations. Depending on the configuration of the bi-component or multi-component fibers or yarns, the fibers or yarns may be splittable along their length by chemical or mechanical action.

Additionally, the face fibers and the primary backing layer may include additives coextruded therein, may be precoated with any number of different materials, including those listed in greater detail below, and/or may be dyed or colored to provide other aesthetic features for the end user with any type of colorant, such as, for example, poly(oxyalkylenated) colorants, as well as pigments, dyes, tints, and the like. Other additives may also be present on and/or within the target fiber or yarn, including antistatic agents, brightening compounds, nucleating agents, antioxidants, UV stabilizers, fillers, permanent press finishes, softeners, lubricants, curing accelerators, and the like.

The face fibers may be dyed or undyed. If the face fibers are dyed, they may be solution dyed. The weight of the face fiber, pile height, and density will vary depending on the desired aesthetics and performance requirements of the end-use for the floor mat. The face fibers may be of loop pile construction, cut pile construction, or combinations of loop pile and cut pile.

The primary backing layer can be any suitable primary backing material. The primary backing layer may be comprised of a woven, nonwoven or knitted material, or combinations thereof. The general purpose of the primary backing layer is to support the tufts of the face fibers. In one aspect, the primary backing layer is a nonwoven polyester spunbond material. One commercially available example of the polyester spunbond material is Lutradur® from Freudenberg Nonwovens of Weinheim, Germany. In another aspect, flat woven polyester tapes, such as Isis™ from Propex of Chattanooga, Tenn., may be utilized. Also, Colback® nonwoven backing material may also be suitable for use. If needed, a primary backing layer made of a woven tape with either staple fibers or nonwoven fabrics affixed can be used. Also, stitch bonded and knitted polyester fabrics may be used.

The tufted pile carpet that includes face fibers tufted into a primary backing layer may be heat stabilized to prevent dimensional changes from occurring in the finished mat. The heat stabilizing or heat setting process typically involves applying heat to the material that is above the glass transition temperature, but below the melting temperature of the components. The heat allows the polymer components to release internal tensions and allows improvement in the internal structural order of the polymer chains. The heat stabilizing process can be carried out under tension or in a relaxed state. The tufted pile carpet is sometimes also stabilized to allow for the fiber and primary backing to shrink prior to the mat manufacturing process.

In one aspect of the present invention, the tufted pile carpet is comprised of fiber tufted into fabric, which is then injection or fluid dyed, and then bonded with a rubber layer or washable latex backing. The carpet fiber may be selected from nylon 6; nylon 6,6; polyester; and polypropylene fiber. The fiber is tufted into a woven or nonwoven substrate. The fiber can be of any pile height and weight necessary to support printing. The tufted pile carpet may be printed using any print process. In one aspect, injection dyeing may be utilized to print the tufted pile carpet.

Printing inks will contain at least one dye. Dyes may be selected from acid dyes, direct dyes, reactive dyes, cationic dyes, disperse dyes, and mixtures thereof. Acid dyes include azo, anthraquinone, triphenyl methane and xanthine types. Direct dyes include azo, stilbene, thiazole, dioxsazine and phthalocyanine types. Reactive dyes include azo, anthraquinone and phthalocyanine types. Cationic dyes include thiazole, methane, cyanine, quinolone, xanthene, azine, and triaryl methine. Disperse dyes include azo, anthraquinone, nitrodiphenylamine, naphthalimide, naphthoquinone imide and methane, triarylmethine and quinoline types.

As is known in the textile printing art, specific dye selection depends upon the type of fiber and/or fibers comprising the washable textile component that is being printed. For example, in general, a disperse dye may be used to print polyester fibers. Alternatively, for materials made from cationic dyeable polyester fiber, cationic dyes may be used.

The printing process of the present invention uses a jet dyeing machine, or a digital printing machine, to place printing ink on the surface of the mat in predetermined locations. One suitable and commercially available digital printing machine is the Millitron® digital printing machine, available from Milliken & Company of Spartanburg, S.C. The Millitron® machine uses an array of jets with continuous streams of dye liquor that can be deflected by a controlled air jet. The array of jets, or gun bars, is typically stationary. Another suitable and commercially available digital printing machine is the Chromojet® carpet printing machine, available from Zimmer Machinery Corporation of Spartanburg, S.C. In one aspect, a tufted carpet made according to the processes disclosed in U.S. Pat. Nos. 7,678,159 and 7,846,214, both to Weiner, may be printed with a jet dyeing apparatus as described and exemplified herein.

Viscosity modifiers may be included in the printing ink compositions. Suitable viscosity modifiers that may be utilized include known natural water-soluble polymers such as polysaccharides, such as starch substances derived from corn and wheat, gum arabic, locust bean gum, tragacanth gum, guar gum, guar flour, polygalactomannan gum, xanthan, alginates, and a tamarind seed; protein substances such as gelatin and casein; tannin substances; and lignin substances. Examples of the water-soluble polymer further include synthetic polymers such as known polyvinyl alcohol compounds and polyethylene oxide compounds. Mixtures of the aforementioned viscosity modifiers may also be used. The polymer viscosity is measured at elevated temperatures when the polymer is in the molten state. For example, viscosity may be measured in units of centipoise at elevated temperatures, using a Brookfield Thermosel unit from Brookfield Engineering Laboratories of Middleboro, Mass. Alternatively, polymer viscosity may be measured by using a parallel plate rheometer, such as made by Haake from Rheology Services of Victoria Australia.

After printing, the tufted pile carpet may be vulcanized with a rubber backing. Once vulcanized, the textile component may be pre-shrunk by washing. After the textile component has been made, it will be custom cut to fit onto the base component (for instances wherein the base component is substantially flat/trayless/without recessed area). The textile component may be cut using a computer controlled cutting device, such as a Gerber machine. It may also be cut using a mechanical dye cutter, hot knife, straight blade, or rotary blade.

The washable floor mat of the present invention may be exposed to post treatment steps. For example, chemical treatments such as stain release, stain block, antimicrobial resistance, bleach resistance, and the like, may be added to the washable mat. Mechanical post treatments may include cutting, shearing, and/or napping the surface of the washable multi-component floor mat.

The performance requirements for commercial matting include a mixture of well documented standards and industry known tests. Tuft Bind of Pile Yam Floor Coverings (ASTM D1335) is performance test referenced by several organizations (e.g. General Services Administration). Achieving tuft bind values greater than 4 pounds is desirable, and greater than 5 pounds even more desirable.

Resistance to Delamination of the Secondary Backing of Pile Yarn Floor Covering (ASTM D3936) is another standard test. Achieving Resistance to Delamination values greater than 2 pounds is desirable, and greater than 2.5 pounds even more desirable.

Pilling and fuzzing resistance for loop pile (ITTS112) is a performance test known to the industry and those practiced in the art. The pilling and fuzzing resistance test is typically a predictor of how quickly the carpet will pill, fuzz and prematurely age over time. The test uses a small roller covered with the hook part of a hook and loop fastener. The hook material is Hook 88 from Velcro of Manchester, N.H. and the roller weight is 2 pounds. The hook-covered wheel is rolled back and forth on the tufted carpet face with no additional pressure. The carpet is graded against a scale of 1 to 5. A rating of 5 represents no change or new carpet appearance. A rating of less than 3 typically represents unacceptable wear performance.

An additional performance/wear test includes the Hexapod drum tester (ASTM D-5252 or ISO/TR 10361 Hexapod Tumbler). This test is meant to simulate repeated foot traffic over time. It has been correlated that a 12,000 cycle count is equivalent to ten years of normal use. The test is rated on a gray scale of 1 to 5, with a rating after 12,000 cycles of 2.5=moderate, 3.0=heavy, and 3.5=severe. Yet another performance/wear test includes the Radiant Panel Test. Some commercial tiles struggle to achieve a Class I rating, as measured by ASTM E 648-06 (average critical radiant flux >0.45=class I highest rating).

The textile component of the floor mat may be washed or laundered in an industrial, commercial or residential washing machine. Achieving 200 commercial washes on the textile component with no structural failure is preferred.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

We claim:

1. A multi-component floor mat comprising:
(a) A textile component comprising (i) a first layer of tufted pile carpet formed by tufting face fibers through a primary backing layer and (ii) a second layer of vulcanized rubber material that contains magnetic particles;
(b) A base component comprised of a magnetic coating wherein the magnetic coating is comprised of magnetic particles and a binder material, wherein the binder materials is selected from a thermoplastic elastomer material, a thermoplastic vulcanite material, and mixtures thereof; and
wherein the textile component and the base component are releasably attachable to one another via magnetic attraction; and
wherein the textile component and the base component further contain at least one edge attachment means.

2. The multi-component floor mat of claim 1, wherein the textile component is magnetically receptive.

3. The multi-component floor mat of claim 1, wherein the base component is permanently magnetized.

4. The multi-component floor mat of claim 1, wherein the textile component of the floor mat can withstand at least one wash cycle in a commercial or residential washing machine whereby the textile component is suitable for re-use after exposure to the at least one wash cycle.

5. The multi-component floor mat of claim 1, wherein the face fibers are selected from the group consisting of synthetic fiber, natural fiber, man-made fiber using natural constituents, inorganic fiber, glass fiber, and mixtures thereof

6. The multi-component floor mat of claim 1, wherein the face fibers are selected from nylon 6; nylon 6,6; polyester; polypropylene; or combinations thereof.

7. The multi-component floor mat of claim 1, wherein the face fibers comprise cut pile, loop pile, or combinations thereof.

8. The multi-component floor mat of claim 1, wherein the face fibers are dyed, printed, or combinations thereof.

9. The multi-component floor mat of claim 1, wherein the primary backing layer is selected from the group consisting of woven material, nonwoven material, knitted material, and combinations thereof.

10. The multi-component floor mat of claim 1, wherein the primary backing layer is selected from the group consisting of synthetic fiber, natural fiber, man-made fiber using natural constituents, inorganic fiber, glass fiber, and mixtures thereof.

11. The multi-component floor mat of claim 1, wherein the vulcanized rubber is selected from the group consisting of nitrile rubber, polyvinyl chloride rubber, ethylene propylene diene monomer (EPDM) rubber, vinyl rubber, thermoplastic elastomer, and mixtures thereof.

12. The multi-component floor mat of claim 1, wherein the magnet particles are non-degradable.

13. The multi-component floor mat of claim 1, wherein the magnetic particles are in an oxidized state.

14. The multi-component floor mat of claim 1, wherein the magnetic particles are in the size range of from 1 micron to 10 microns.

15. The multi-component floor mat of claim 1, wherein the magnetic particles are magnetizable magnetic particles selected from the group consisting of Fe₃O₄, SrFe₃O₄, NdFeB, AlNiCo, CoSm and other rare earth metal based alloys, and mixtures thereof.

16. The multi-component floor mat of claim 1, wherein the magnetic particles are magnetically receptive particles selected from the group consisting of Fe₂O₃, Fe₃O₄, steel, iron particles, and mixtures thereof.

17. The multi-component floor mat of claim 1, wherein the magnetically receptive particles are paramagnetic or superparamagnetic.

18. The multi-component floor mat of claim 1, wherein the magnetic particle loading is in the range from 10% to 70% by weight in the textile component.

19. The multi-component floor mat of claim 1, wherein the magnetic particle loading is in the range from 10% to 90% by weight in the base component.

20. The multi-component floor mat of claim 1, wherein at least one of the textile and base components is characterized as having a functionally graded magnetic particle distribution.

21. The multi-component floor mat of claim 1, wherein the magnetic particles are ferrite.

22. The multi-component floor mat of claim 1, wherein the strength of magnetic attraction is greater than 50 gauss.

23. The multi-component floor mat of claim 1, wherein the vulcanized rubber contains recycled rubber material.

24. The multi-component floor mat of claim 1, wherein the at least one edge attachment means is selected from the group consisting of hook and loop fastening systems, mushroom-type hook fastening systems, and combinations thereof.

25. The multi-component floor mat of claim 1, wherein the at least one edge attachment means of the textile component is narrower in width than the edge attachment means of the base component.
